(19) United States
(12) Patent Application Publication
(10) Pub. No.: US 2025/0347401 A1
(43) Pub. Date: Nov. 13, 2025

(54) LIGHTING ARRANGEMENT WITH A ROTATABLE LIGHTING UNIT

(71) Applicant: SIGNIFY HOLDING B.V., EINDHOVEN (NL)

(72) Inventors: BARTEL MARINUS VAN DE SLUIS, EINDHOVEN (NL); MARCELLINUS PETRUS CAROLUS MICHAEL KRIJN, EINDHOVEN (NL); LEENDERT TEUNIS ROZENDAAL, VALKENSWAARD (NL); ANNA WILHELMINA MARIA DE BEST, VELDHOVEN (NL)

(21) Appl. No.: 18/863,369

(22) PCT Filed: May 15, 2023
(86) PCT No.: PCT/EP2023/062997

§ 371 Date: Nov. 6, 2024

(30) Foreign Application Priority Data
May 30, 2022 (EP) 22176196.8

(51) Int. Cl. F21V 21/30; F21V 7/00; F21Y 115/10

(52) U.S. Cl. CPC F21V 21/30; F21V 7/00; F21Y 2115/10

(57) ABSTRACT

A lighting arrangement comprising a lighting unit, comprising a light source arranged to emit light, and a housing comprising a reflective inner surface and an opening extending in a plane, P. The opening is oppositely arranged the reflective inner surface, wherein the lighting unit is rotatably fastened to a first rotation axis, Ai, of the housing. The first rotation axis, Ai, is arranged adjacent the opening and parallel to the plane, P, and the lighting unit is rotatable around the first rotation axis, Ai, between a first position and a second position, through the opening. In the first position, the lighting unit is at least partially enclosed by the housing, wherein the lighting unit is arranged to illuminate the reflective inner surface for an output of the light through the opening, and in the second position, the lighting unit is arranged at least partially outside the housing.

### FIELD OF THE INVENTION

The present invention generally relates to a lighting arrangement. More specifically, the present invention is related to a lighting arrangement comprising a rotatable lighting unit.

### BACKGROUND OF THE INVENTION

The use of spotlights for illumination purposes is utilized in a vast number of areas, such as in hospitals and different types of stage performances, as well as for private use in the home. The property of the spotlight being able to produce illumination in a well-defined section may be desirable in mentioned areas, along with additional areas of implementation.

In some spotlight designs, a rotation of the spotlight may be feasible, allowing the direction of the emitting light beam from the spotlight to be changed. This enables the space in which the spotlight resides within to be further illuminated, thus presenting a more versatile spotlight. Some designs present an individually rotatable spotlight, whereas other disclose a linearly rotatable spotlight, having several light sources.

Having light emitting diodes (LEDs) as a light source in a spotlight further expands the area of use of the spotlight. LEDs have numerous advantages over conventional light sources, such as being more energy-efficient, having a longer lifespan and a higher efficiency, as well as providing design flexibility. The use of LEDs in spotlights may also permit various settings of the emitted light to be modified such as adjusting the intensity of the light, i.e. dimming, in an accessible manner.

The emitted light may also be redirected in a manual manner via a rotation, such as directing the emitted light beam towards a ceiling, to create an indirect lighting experience. This setting may require additional space for the spotlight, which furthermore may be disadvantageous as it is often preferable to have a relatively compact spotlight. A more compact spotlight may align with desired aesthetics and facilitate handling of the spotlight.

Hence, it is of interest to provide alternatives to the spotlights of the prior art in order to improve the usage of such spotlight in regard to space-efficiency and multilateral areas of use.

DE202016101553U1 discloses a recessed luminaire with swiveling LED light source.

### SUMMARY OF THE INVENTION

It is an object of the present invention to provide a lighting arrangement which can combine several lighting functions, whilst at the same time being compact and/or space efficient.

This and other objects are achieved by a lighting arrangement having the features in the independent claim. Preferred embodiments are defined in the dependent claims.

Hence, according to the present invention, there is provided a lighting arrangement comprising at least one lighting unit, comprising at least one light emitting diode, LED, as a light source arranged to emit light, and a housing comprising a reflective inner surface. The housing further comprises an opening extending in a plane, P, wherein the opening is oppositely arranged (a portion, such as a part of a curved portion, of) the reflective inner surface. The at least one lighting unit is rotatably fastened to at least one first rotation axis, Aᵢ, of the housing, wherein the at least one first rotation axis, Aᵢ, is arranged adjacent the opening and parallel to the plane, P. Furthermore, the at least one lighting unit is rotatable around the at least one first rotation axis, Aᵢ, between a first position and a second position, through the opening. In the first position, the at least one lighting unit is at least partially enclosed by, i.e. recessed in or accommodated in a cavity of the housing, wherein the at least one lighting unit is arranged to illuminate the reflective inner surface for an output via reflection at the inner surface of the light through the opening. In the second position, the at least one lighting unit is arranged at least partially outside the housing. The lighting unit is rotatable inside the housing about the at least one first rotation axis Aᵢ, over an inner rotation angle α>=90°, such that when the lighting unit is in the first position, i) in projection along a normal to plane P the opening and the lighting unit do not overlap, and ii) the lighting unit emits light into the housing in a direction away from the opening.

Thus, the present invention is based on the concept or idea of a compact lighting arrangement or system which is able to provide multipurpose light by enabling a lighting unit to rotate at least partially within a housing with a reflective interior. Thus, outgoing light from the lighting arrangement may serve different lighting purposes in regard to the rotation of the lighting unit relative the housing and its reflective interior.

It will be appreciated that the lighting arrangement is relatively compact. The lighting arrangement is relatively compact as it provides several lighting functions in one arrangement by the rotation axis/axes, Aᵢ. Thus, the lighting arrangement requires less space and is easier handled during e.g., transportation and/or installation compared to prior art arrangements.

It should also be noted that the lighting arrangement is able to provide multipurpose light e.g., diffuse light, downlight, and accent light. This may reduce the need of several different lighting arrangements to provide desired lighting functions. This may be favored in various environments where specific light settings may be desired and/or that the light requirements may vary, such as in hospitals, museums, and theatres etc., as well as in private homes. When the lighting unit is in the first position, i.e. accommodated inside the inner cavity of the housing, the lighting arrangement is in an indirect mode and provides indirect illumination. In said indirect mode the inner of the housing acts as a mixing chamber, rendering that the opening has a uniform light intensity essentially without distortion by the lighting unit. Alternatively or additionally, in said first position the contour of the lighting unit is not visible through said opening in a viewing direction along said normal.

The present invention is further advantageous in that it presents a more secure lighting arrangement in relation to at least some external forces during e.g. transportation and/or installation thereof. Lighting arrangements may often require handling with care, as they may be fragile and/or comprise sensitive components such as light sources and electrical wirings, etc. The light source(s) of the lighting arrangement may be protected as a result of that the lighting unit(s) comprising the light source(s) is (are) able to be rotated such that the lighting unit(s) is (are) at least partially enclosed by the housing.

According to the lighting arrangement of the present invention, there is provided a lighting arrangement comprising a housing, wherein the housing further comprises a reflective inner surface. By the term “reflective surface”, it is here meant a surface or an area which is configured to reflect incoming (incident) light, i.e. that affects at least some incoming light as to change the direction of at least some of the outgoing light. By the term “fasten”, it is here meant, but not limited to, securing, fixating, holding and/or locking. Hence, by “lighting unit is rotatably fastened to at least one first rotation axis”, it is here meant that the lighting unit(s) may be secured, fixated, held and/or locked to the first rotation axis(es), Aᵢ, in a rotatable manner.

To enable the inner rotation angle α of at least 90 degrees, the housing should have an inner height Hᵢ which is the same or larger than a maximum width Wₘ of the lighting unit (or optical unit) in a radial direction with respect to the at least one first rotation axis Aᵢ. Preferably, the opening of the housing is bordered by a rim, essentially parallel and/or in plane with the opening, which rim has a width Wᵣ>=Wₘ in a radial direction with respect to the at least one first rotation axis Aᵢ, at least at the location where the lighting unit (or optical unit) is fastened to the at least one first rotation axis Aᵢ. In an embodiment, the optical unit may comprise an aperture having a size Wₒ and shape, wherein the size Wₒ of the opening of the housing matches with the size Wₘ and shape of the aperture of the optical unit, i.e. matches means that the opening is just large enough to enable rotation of (the aperture) of the optical unit through the opening over the first rotation axis A₁, i.e. Wₒ≈Wₘ, yet slightly larger. This has the advantage, when the optical unit when the aperture is flush with the opening of the housing in plane P, i.e. the optical unit is in a specific intermediate position, that the opening is essentially fully covered by the aperture of the optical unit without any significant disturbing slit between housing and optical unit, thus rendering the lighting arrangement aesthetically attractive.

According to an embodiment of the present invention, the at least one lighting unit may comprise at least one optical unit configured to direct the light. Furthermore, the at least one optical unit may comprise at least one of a lens element and a reflector element. Hence, the at least one optical unit may comprise a lens element and/or a reflector element. By the wordings “lens element” and “reflector element”, it is here meant elements that may affect and/or influence light. More specifically, it may be elements that may act upon incoming light in such a manner that at least some light can pass through the elements. The elements may affect and/or influence the light according to e.g. optical guidance and/or collimation of the light. The present embodiment is advantageous in that the optical unit(s) may enable a desired distribution of the light, as well as providing an increased control over the beam of the light.

According to an embodiment of the present invention, the at least one optical unit may comprise an aperture. Furthermore, the at least one optical unit may be arranged to direct (at least part of) the light (in a direction perpendicular to the at least one first rotation axis, Aᵢ,) (directly) through the aperture, and the at least one optical unit may be rotatably fastened to the at least one first rotation axis, Aᵢ, at the periphery of the aperture. In other words, the optical unit(s) may be rotatably fastened to the first rotation axis(es), Aᵢ, at the periphery of the aperture of the optical unit(s). By the term “periphery”, it is here meant the outer limit or edge. The present embodiment is particularly advantageous in that the corresponding rotational angle around the first rotation axis(es), Aᵢ, of the lighting arrangement may be increased. This enables a larger space to be illuminated, with a wider reach of light.

According to an embodiment of the present invention, the lighting arrangement may comprise a control unit configured for individual control of the at least one light source via at least one setting of the at least one light source. Thus, the control unit may control the light source(s) individually by controlling (a) setting(s) of the light source(s). By the term “setting”, it is here meant a property of the light emitted by the light source(s), such as different wavelengths, colors, intensities, etc. The present embodiment is advantageous in that it presents a more versatile lighting arrangement in being further adaptable regarding different lighting needs, requirements and/or desired settings as well as being aesthetically attractive.

According to an embodiment of the present invention, the control of the at least one light source via the at least one setting may be based on an input from at least one of a sensor and a user. Hence, the light source(s) may be controlled based on input from a sensor and/or a user. The present embodiment is further advantageous in that it presents an even more versatile lighting arrangement by its automatic control (via the sensor(s)) and/or its manual control (via the user). The additional input from the sensor and/or the user may result in a more efficient lighting arrangement in terms of e.g. power consumption and lighting requirements and/or desired settings.

According to an embodiment of the present invention, the control of the at least one light source via the at least one setting may be based on the rotation of the at least one lighting unit around the at least one first rotation axis, Aᵢ, between the first position and the second position. In other words, the light source(s) may be controlled based on the rotation of the lighting unit(s) around the first rotation axis(es), Aᵢ, between the first and second position. The present embodiment is advantageous in that it presents an additional approach in controlling the light source(s) via the setting(s). This entails a more adaptable lighting arrangement with regards to various lighting needs and/or desires.

According to an embodiment of the present invention, the at least one setting may be at least one of color, intensity, beam direction and beam distribution of the light. The present embodiment is advantageous in that it is further adaptable regarding different lighting needs, requirements and/or desired settings as well as being aesthetically attractive.

According to an embodiment of the present invention, the lighting arrangement may comprise at least one first rotational mechanism fastened to the housing and the at least one lighting unit and adjacent to the opening. The first rotational mechanism(s) may be configured to rotate the lighting unit(s) around the first rotation axis(es), Aᵢ. The present embodiment is particularly advantageous in that it may facilitate the rotation of the lighting unit(s) around the first rotation axis(es), Aᵢ, and present (a) more robust lighting unit(s).

According to an embodiment of the present invention, the at least one first rotational mechanism may comprise a motor configured to rotate the at least one lighting unit around the at least one first rotation axis, Aᵢ. In other words, the rotation of the lighting unit(s) around the first rotation axis(es), Aᵢ, may be accomplished by the motor. The present embodiment is advantageous in that it presents a motorized rotation of the lighting unit(s). This may be preferable if e.g. the lighting arrangement is installed in areas which may be difficult to reach or access. Additionally, the present embodiment enables a more precise rotation of the lighting unit(s) as well as a greater control overall in regard to lighting needs and/or desires e.g., rotating the lighting unit(s) relative to a predetermined schedule.

According to an embodiment of the present invention, the at least one first rotational mechanism may be configured to rotate the at least one lighting unit around the at least one first rotation axis, Aᵢ, between a plurality of predetermined positions, respectively. The at least one lighting unit may be securable at each predetermined position. Thus, the lighting unit(s) may be rotated by the first rotational mechanism(s) between, and fixated at, various predetermined positions. By the term “securable”, it is here meant, but not limited to, fixable, fastenable, holdable and/or lockable. The present embodiment is particularly advantageous in that it may facilitate different lighting desires and/or needs, e.g., a provision of light to a specific area in a space wherein the lighting arrangement resides.

According to an embodiment of the present invention, the lighting arrangement may comprise a power track extending along the at least one first rotation axis, Aᵢ. The at least one lighting unit may be rotatably fastened to the power track, wherein the power track may be configured to supply electric power to the at least one lighting unit. Hence, the lighting unit(s) may be rotated around the first rotation axis(es), Aᵢ. The present embodiment is advantageous in that it enables the lighting arrangement to be installed in more varied settings. Additionally, the lighting unit(s) may be rotatably fastened at various positions along the power track, providing a more versatile lighting arrangement in terms of e.g., delivering light to a distinct area in a space that the lighting arrangement occupies and regarding desired appearance.

According to an embodiment of the present invention, the lighting arrangement may comprise at least one hinge. The at least one lighting unit may be rotatably fastened to the at least one hinge, wherein the at least one hinge may be configured to supply electric power to the at least one lighting unit. The present embodiment is particularly advantageous in that it may further facilitate the rotation of the lighting unit(s) around the first rotation axis(es), Aᵢ, and present (an) even more robust lighting unit(s).

According to an embodiment of the present invention, the at least one lighting unit may comprise at least one second rotational mechanism configured to rotate the at least one lighting unit around at least one second rotation axis, Bᵢ. The second rotation axis(es), Bᵢ, may be arranged adjacent the opening, parallel to the plane, P, and perpendicular to the at least one first rotation axis, Aᵢ. The present embodiment is advantageous in that the beam of the light source(s) may be directed in additional directions, thus improving the distribution of the light from the light source(s). This enables a larger space to be illuminated, with a wider reach of the light from the light source(s).

According to an embodiment of the present invention, the lighting arrangement may elongate in a first length direction, L₁, parallel to the at least one first rotation axis, Aᵢ. The present embodiment is particularly advantageous in that it results in a more aesthetically attractive lighting arrangement. Additionally, the embodiment of the present invention enables a more flexible and customized lighting arrangement.

According to an embodiment of the present invention, the at least one lighting unit may elongate in a second length direction, L₂, parallel to the at least one first rotation axis, Aᵢ. The present embodiment is advantageous in that an elongated lighting unit enables an even more versatile lighting arrangement e.g., in the lighting unit having a linear array of light sources. This facilitates to providing a greater amount of illumination to the space wherein the lighting arrangement resides, as well as contributing to the lighting arrangement being more aesthetically attractive.

Further objectives of, features of, and advantages with, the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiments of the invention.

FIG. 1 schematically shows an overview of a lighting arrangement according to exemplifying embodiments of the present invention,

FIG. 2 schematically shows a cross-sectional view of a lighting arrangement according to an exemplifying embodiment of the present invention, comprising a sensor and a control unit,

FIGS. 3a-c schematically show cross-sectional views of a lighting arrangement according to exemplifying embodiments of the present invention,

FIGS. 4a-b schematically show cross-sectional views of a lighting arrangement according to exemplifying embodiments of the present invention, and

FIG. 5 schematically shows an overview of a lighting arrangement according to an exemplifying embodiment of the present invention.

### DETAILED DESCRIPTION

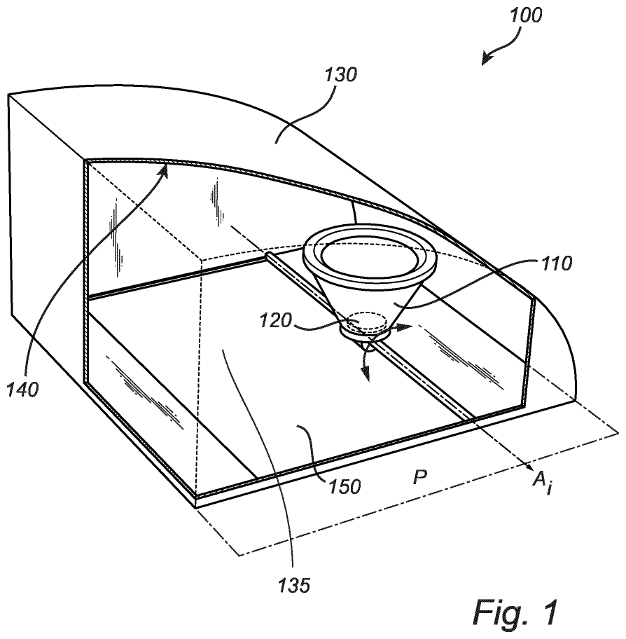

FIG. 1 is a schematically overview of a lighting arrangement 100 according to an exemplifying embodiment of the present invention. The lighting arrangement 100 comprises a housing 130 that comprises a reflective inner surface 140 and an opening 150. Thus, the reflective inner surface 140 may occupy only (a) portion(s) or the entirety of the interior of the housing 130. The reflective inner surface 140 can obtain its reflection property by comprising e.g. a reflective coating or a sheet material. Additionally, the type of reflection from the reflective inner surface 140 may be e.g. specular reflection and/or diffuse reflection. The reflection type may be obtained by properties of the reflective inner surface 140, e.g. that portions of its surface are regular and/or irregular. Furthermore, the opening 150 is extending in a plane, P, wherein the opening 150 is oppositely arranged the reflective inner surface 140. FIG. 1 discloses the housing 130 having the shape of a quarter cylinder with an elliptic cross section. However, it should be noted that the housing 130 may take on alternative shapes, e.g., a half cylinder, a sphere, a triangular prism, etc.

The lighting arrangement 100 further comprises at least one lighting unit 110 further comprising at least one light source 120. Hence, the lighting arrangement 100 may comprise a plurality of lighting units 110. Similarly, the lighting unit(s) 110 may comprise a plurality of light sources 120. Where a plurality of light sources 120 is present, the light sources 120 may be arranged directly adjacent to each other, or slightly spaced apart. Moreover, a plurality of light sources 120 may be arranged in a linear array. For example, the light source(s) 120 may preferably be or comprise light-emitting diodes, LED(s), but may alternatively be or comprise incandescent light source(s), fluorescent light source(s), etc. Where a plurality of lighting units 110 is present, the lighting units 110 may be arranged in a linear array. It may also be that the lighting arrangement 100 comprises a single lighting unit 110 and a single light source 120. In this case, the single lighting unit 110 and the single light source 120 may constitute a linear (light) array.

The lighting unit(s) 110 is (are) rotatably fastened to the first rotation axis(es), Aᵢ, of the housing 130. The first rotation axis(es), Aᵢ, is (are) arranged adjacent the opening 150, and parallel to the plane, P. The lighting unit(s) 110 is (are) rotatable around the first rotation axis(es), Aᵢ, between a first position and a second position, through the opening 150. Hence, the lighting unit(s) 110 may be rotated around the first rotation axis(es), Aᵢ, between various positions that are positioned between the first position and the second position. In the first position, the lighting unit(s) 110 is (are) at least partially enclosed by, or recessed in or accommodated in a cavity 135 of the housing 130, wherein the lighting unit(s) 110 is (are) arranged to illuminate the reflective inner surface 140 for an output of the light through the opening 150. The reflective inner surface 140 may be completely illuminated or only partially. In the second position, the lighting unit(s) 110 is (are) arranged at least partially outside the housing 130. Consequentially, the lighting unit(s) 110 in the second position may illuminate the reflective inner surface 140 to some extent or not at all.

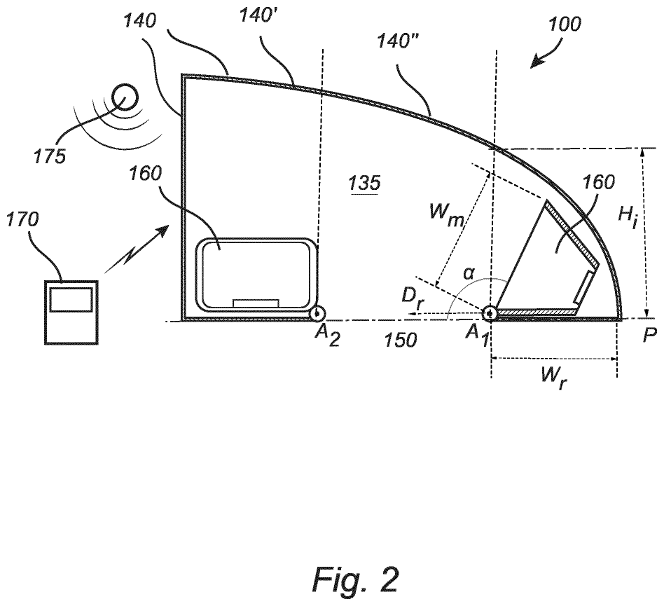

FIG. 2 is a schematically cross-sectional view of a lighting arrangement 100 according to an exemplifying embodiment of the present invention. It should be noted that the part of a lighting arrangement 100 shown in FIG. 2 has several features in common with the lighting arrangement 100 shown in FIG. 1, and it is hereby referred to FIG. 1 and the associated text for an increased understanding of some of the features and/or functions of the lighting arrangement 100. FIG. 2 discloses a plurality of first rotation axes, here exemplified as axis A₁ and axis A₂. The at least one lighting unit 110 comprises at least one optical unit 160, in the figure a reflector element (but which alternatively or additionally could comprise a refractive body, such as a lens element), configured to direct the light. The optical unit(s) 160 may direct the light via e.g., optical guidance of the light and collimation of the light.

The lighting arrangement 100 further comprises an aperture, wherein the optical unit(s) 160 is (are) arranged to direct part of the light in a direction perpendicular to the at least one first rotation axis, Aᵢ, directly, hence without being reflected by the reflector element, through the aperture. Furthermore, the optical unit(s) 160 is (are) rotatably fastened to the at least one first rotation axis, Aᵢ, at the periphery of the aperture. FIG. 2 discloses a plurality of first rotation axes, A₁ and A₂. Hence, the optical unit(s) 160 is (are) rotatably fastened to the first rotation axes, A₁ and A₂, respectively, along the light emission window of the lighting unit(s) 110.

The lighting arrangement 100 further comprises a control unit 170 configured for individual control of the light source(s) 120 via at least one setting of the light source(s) 120. The control unit 170 may be connected to the light arrangement 100 by wire or wirelessly. As the control unit 170 may control the light source(s) 120 independently, different light source(s) 120 may have different settings in regard to e.g. brightness and/or color. The control of the light source(s) 120 via the setting(s) is based on an input from at least one of a sensor 175 and/or a user. In the case where the control is based on an input from the sensor 175, the sensor 175 may be configured to e.g., detect movement. For example, if any movement (of a person) is detected, the sensor 175 may generate a sensor signal and send the generated signal to the control unit 170, whereas the control unit 170 may control the light source(s) 120 to e.g. increase the brightness and/or color. Furthermore, the control of the light source(s) 120 is based on the rotation of the lighting unit(s) 110 around the at least one first rotation axis, Aᵢ, between the first position and the second position. For instance, the light source(s) 120 may have different settings in regard to if the lighting unit(s) 110 is (are) completely enclosed by (or accommodated in) the cavity 135 of the housing 130 or arranged completely outside the housing 130. The setting(s) may be at least one of color, color temperature, intensity, beam direction and beam distribution of the light. For example, the color may be adjusted to e.g., render a cool-white light output to imitate the sky, a pleasant ambiance color defined by a potential user or be based on a color derived from a light scene active in the space wherein the lighting arrangement 100 resides within.

It should be noted that the setting decisive factors, i.e., the setting being based on the rotation of the lighting unit(s) 110 and/or input from the sensor 175 and/or the user, may be manually and/or automatically performed. For example, the sensor 175 may automatically detect any movement within the space where the lighting arrangement 100 resides to enable e.g., changing the value of the luminosity, whereas the lighting unit(s) 110 may be manually rotated in terms of enabling e.g., a change of the color of the emitted light.

The lighting arrangement 100 disclosed in FIG. 2 comprises a plurality of lighting units 110 and is exemplified as having two lighting units 110. It should be noted that the lighting units 110 are arranged on opposite sides of the opening 150, rotatably fastened to at least one first rotation axis, Aᵢ, of the housing 130, more specifically to axis A₁ and axis A₂ respectively. The opening 150 is extending in plane, P, wherein the opening 150 is oppositely arranged a part 140″ of a curved portion 140′ of the reflective inner surface 140. To enable the inner rotation angle α of at least 90 degrees, the housing 130 has an inner height Hᵢ at the location of the first rotation axis A₁ which is the same or larger than a maximum width Wₘ of the optical unit 160 (or lighting unit) in a radial direction Dᵣ with respect to the first rotation axis A₁. Preferably, the opening 150 of the housing 130 is bordered by a rim 155, essentially also lying in plane P and in plane with the opening 150, which rim 155 has a width Wᵣ>=Wₘ in the radial direction Dᵣ with respect to the first rotation axis A₁, at the location where the optical unit 160 is fastened to the first rotation axis A₁. The disclosed embodiment enables a combination of indirect, diffuse light and directional light, such as down or accent light, at several positions along the housing 130.

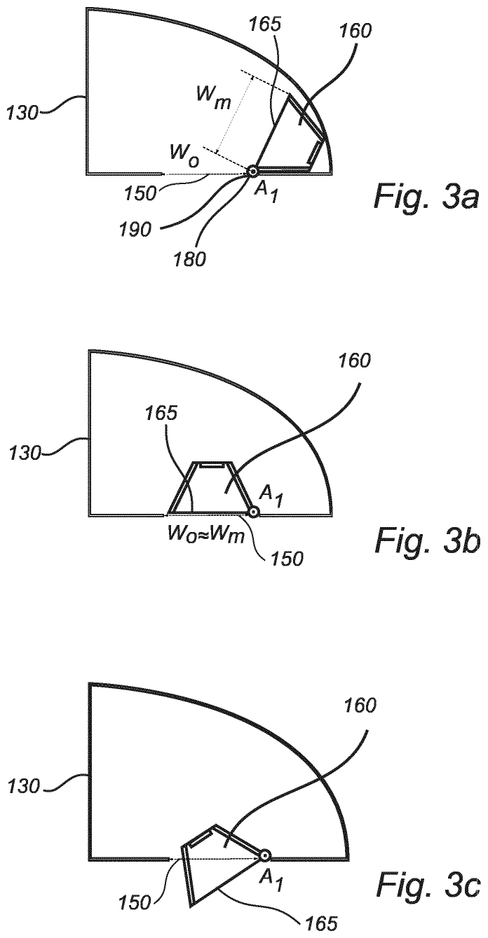

FIGS. 3a-c are schematically cross-sectional views of a lighting arrangement 100 according to exemplifying embodiments of the present invention. It should be noted that the part of a lighting arrangement 100 shown in FIGS. 3a-c has several features in common with the lighting arrangement 100 shown in FIG. 1, and it is hereby referred to FIG. 1 and the associated text for an increased understanding of some of the features and/or functions of the lighting arrangement 100. The lighting arrangement 100 comprises at least one first rotational mechanism 180 fastened to the housing 130 and the lighting unit 110 and adjacent to the opening 150. The first rotational mechanism(s) 180 is (are) configured to rotate the lighting unit(s) 110 around the at least one first rotation axis(es), Aᵢ. FIGS. 3a-c discloses a single first rotation axis, A₁. The first rotational mechanism(s) 180 may be a revolute joint e.g., a hinge, a pin, or the like.

The first rotational mechanism(s) 180 comprises a motor 190 configured to rotate the lighting unit(s) 110 around the first rotation axis(es), Aᵢ. The motor 190 enables a motorized rotation of the lighting unit(s) 110. However, it should be noted that the motor 190 may be any other type of actuator that enables a rotation of the lighting unit(s) 110. Additionally, the lighting unit(s) 110 may be motorically rotated by the motor 190 and/or manually rotated.

The first rotational mechanism(s) 180 is configured to rotate the lighting unit(s) 110 around the first rotation axis(es), Aᵢ, between a plurality of predetermined positions respectively. The lighting unit(s) 110 is (are) securable at each predetermined position. Hence, the first rotational mechanism(s) 180 may have mechanical resistance enabling the light unit(s) 110 to remain stable at each predetermined position. The rotation of the lighting unit(s) 110 may be performed in a continuous movement or in several steps.

In FIG. 3a, the lighting unit 110 is in the first position, illuminating the reflective inner surface 140 for an output of the light through the opening 150 of the housing 130. In this position, the outgoing light has the character of indirect, diffuse lighting. In this exemplifying embodiment of the present invention, the lighting unit 110 is fully enclosed by the housing 130. In FIG. 3b, the lighting unit 110 is in an intermediate position. In this position, the lighting unit 110 illuminates a smaller portion of the reflective inner surface 140 than in the first position, if any. In the intermediate position, the outgoing light has the character of downlight. In FIG. 3c, the lighting unit 110 is in the second position, illuminating a smaller portion of the reflective inner surface 140 than in the first position, if any. The second position of the lighting unit 110 may be partially outside or fully outside the housing 130. A shown in FIGS. 3a-c, the optical unit 160 comprises an aperture 165 with a size Wₒ and shape, wherein the size Wₒ of the opening 150 of the housing 130 matches with the size Wₘ and shape of the aperture 165 of the optical unit 160, i.e. matches means that the opening 150 is just large enough to enable rotation of (the aperture 165) of the optical unit 160 through the opening 150 over the first rotation axis A₁, i.e. Wₒ≈Wₘ, yet slightly larger.

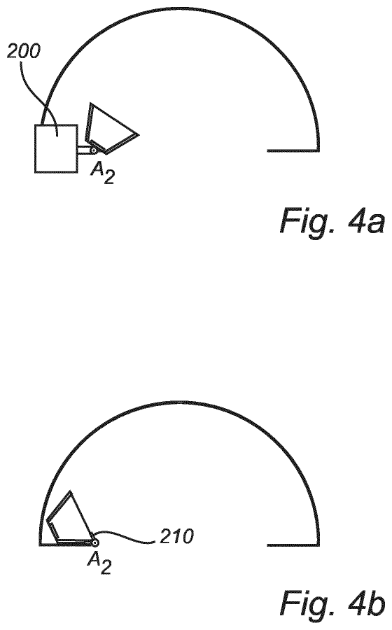

FIGS. 4a-b are schematically cross-sectional view of a lighting arrangement 100 according to exemplifying embodiments of the present invention. It should be noted that the part of a lighting arrangement 100 shown in FIGS. 4a-b has several features in common with the lighting arrangement 100 shown in FIG. 1, and it is hereby referred to FIG. 1 and the associated text for an increased understanding of some of the features and/or functions of the lighting arrangement 100. In FIG. 4a, the lighting arrangement 100 comprises a power track 200 extending along the at least one first rotation axis, Aᵢ. FIG. 4a discloses a single first rotation axis, A₂. The lighting unit(s) 110 is (are) rotatably fastened to the power track 200, wherein the power track 200 is configured to supply electric power to the lighting unit(s) 110. It should be noted that the power track 200 may be arranged within or outside the housing 130.

In FIG. 4b, the lighting arrangement 100 comprises at least one hinge 210, wherein the lighting unit(s) 110 is (are) rotatably fastened to the hinge(s) 210. The hinge(s) 210 is (are) configured to supply electric power to the lighting unit(s) 110. The hinge(s) 210 may be electrically insulated from its surrounding and may function as (a) power providing electrode(s). It is worth noting that a portion of the hinge 210 in FIG. 4b is arranged on the interior of the housing 130. A portion of the hinge 210 may as well be arranged on the exterior of the housing 130.

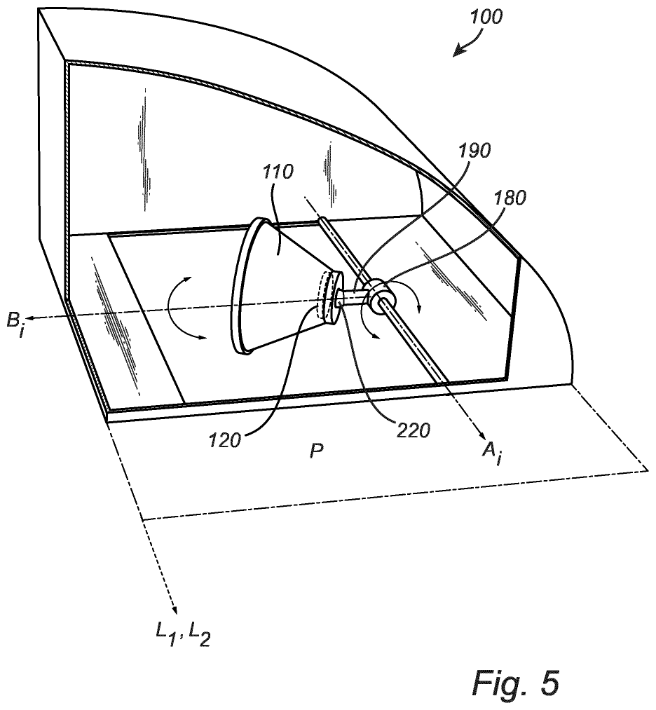

FIG. 5 is a schematically overview of a lighting arrangement 100 according to an exemplifying embodiment of the present invention. It should be noted that the part of a lighting arrangement 100 shown in FIG. 5 has several features in common with the lighting arrangement 100 shown in FIG. 1, and it is hereby referred to FIG. 1 and the associated text for an increased understanding of some of the features and/or functions of the lighting arrangement 100. The lighting arrangement 100 comprises at least one second rotational mechanism 220 configured to rotate the at least one lighting unit 110 around at least one second rotation axis, Bᵢ. The second rotation axis(es), Bᵢ, is (are) arranged adjacent the opening 150, parallel to the plane, P, and perpendicular to the at least one first rotation axis, Aᵢ. FIG. 5 discloses a single first rotation axis, A₁, and a single second rotation axis, B₁. The rotation of the lighting unit(s) 110 around the first rotation axis, A₁, and around the second rotation axis, B₁, may be performed independently of each other. In the exemplifying embodiment of the present invention, the lighting arrangement 100 further comprises at least one first rotational mechanism 180 comprising a motor 190, wherein the motor 190 is configured to rotate the lighting unit(s) 110 around the first rotation axis, A₁. The motor 190 enables a motorized rotation of the lighting unit(s) 110 around the first rotation axis, A1. It should be noted that the lighting unit(s) 110 may e.g., be motorically and/or manually rotated by the motor 190 around the first rotation axis, A₁, and manually rotated around the second rotation axis, A₂.

In FIG. 5, the lighting arrangement 100 elongates in a first length direction, L₁, parallel to the first rotation axis, A₁. Furthermore, the lighting unit(s) 110 elongates in a second length direction, L₂, parallel to the first rotation axis A₁. The length directions, L₁ and L₂, may coincide.

It is worth bearing in mind that the lighting arrangement 100 may be comprised within a lighting system as modules (not disclosed) with a plurality of lighting arrangements 100. The lighting arrangements 100 may be mechanical and/or electrical connected to one or more neighboring modules to transfer power and/or data signals. Furthermore, the housing 130 in FIG. 5 may be part of a pendant (linear) luminaire (not disclosed) that e.g., hangs above a table or above an object presentation area. Alternately, the housing 130 may be integrated in e.g., a ceiling to give a pleasant and sleek impression.

The person skilled in the art realizes that the present invention by no means is limited to the preferred embodiments described above. On the contrary, many modifications and variations are possible within the scope of the appended claims. For example, one or more of the at least one lighting unit 110, the housing 130, the opening 150 etc., may have different shapes, dimensions and/or sizes than those depicted/described.

1. A lighting arrangement, comprising
at least one lighting unit, comprising at least one light emitting diode, LED, as a light source arranged to emit light,
a housing, comprising a reflective inner surface, and an opening extending in a plane, P, wherein the opening is oppositely arranged the reflective inner surface,
wherein the at least one lighting unit is rotatably fastened to at least one first rotation axis, Aᵢ, of the housing, wherein the at least one first rotation axis, Aᵢ, is arranged adjacent the opening and parallel to the plane, P, and wherein the at least one lighting unit is rotatable around the at least one first rotation axis, Aᵢ, between a first position and a second position, through the opening, wherein
in the first position, the at least one lighting unit is recessed in the housing, wherein the at least one lighting unit is arranged to illuminate the reflective inner surface for an output via reflection at the inner surface of the light through the opening, and
in the second position, the at least one lighting unit is arranged at least partially outside the housing,
wherein the lighting unit is rotatable inside the housing about the at least one first rotation axis Aᵢ, over an inner rotation angle α>=90°, such that when the lighting unit is in the first position, i) in projection along a normal to plane P the opening and the lighting unit do not overlap, and ii) the lighting unit emits light into the housing in a direction away from the opening.

2. The lighting arrangement according to claim 1, wherein the at least one lighting unit further comprises at least one optical unit configured to direct the light, wherein the at least one optical unit comprises at least one of a lens element and a reflector element.

3. The lighting arrangement according to claim 2, wherein the at least one optical unit comprises an aperture, wherein the at least one optical unit is arranged to direct at least part of the light in a direction perpendicular to the at least one first rotation axis, Aᵢ, through the aperture, and wherein the at least one optical unit is rotatably fastened to the at least one first rotation axis, Aᵢ, at the periphery of the aperture.

4. The lighting arrangement according to claim 1, further comprising a control unit configured for individual control of the at least one light source via at least one setting of the at least one light source.

5. The lighting arrangement according to claim 4, wherein the control of the at least one light source via the at least one setting is based on an input from at least one of a sensor and a user.

6. The lighting arrangement according to claim 4, wherein the control of the at least one light source via the at least one setting is based on the rotation of the at least one lighting unit around the at least one first rotation axis, Aᵢ, between the first position and the second position.

7. The lighting arrangement according to claim 4, wherein the at least one setting is at least one of color, intensity, beam direction and beam distribution of the light.

8. The lighting arrangement according to claim 1, further comprising at least one first rotational mechanism fastened to the housing and the at least one lighting unit and adjacent to the opening, wherein the at least one first rotational mechanism is configured to rotate the at least one lighting unit around the at least one first rotation axis, Aᵢ.

9. The lighting arrangement according to claim 8, wherein the at least one first rotational mechanism comprises a motor configured to rotate the at least one lighting unit around the at least one first rotation axis, Aᵢ.

10. The lighting arrangement according to claim 8, wherein at least one first rotational mechanism is configured to rotate the at least one lighting unit around the at least one first rotation axis, Aᵢ, between a plurality of predetermined positions, respectively, wherein the at least one lighting unit is securable at each predetermined position.

11. The lighting arrangement according to claim 1, further comprising a power track extending along the at least one first rotation axis, Aᵢ, wherein the at least one lighting unit is rotatably fastened to the power track, wherein the power track is configured to supply electric power to the at least one lighting unit.

12. The lighting arrangement according to claim 1, further comprising at least one hinge, wherein the at least one lighting unit is rotatably fastened to the at least one hinge, wherein the at least one hinge is configured to supply electric power to the at least one lighting unit.

13. The lighting arrangement according to claim 1, wherein the at least one lighting unit comprises at least one second rotational mechanism configured to rotate the at least one lighting unit around at least one second rotation axis, Bᵢ wherein the at least one second rotation axis, Bᵢ, is arranged adjacent the opening, parallel to the plane, P, and perpendicular to the at least one first rotation axis, Aᵢ.

14. The lighting arrangement according to claim 1, wherein the lighting arrangement elongates in a first length direction, L₁, parallel to the at least one first rotation axis, Aᵢ.

15. The lighting arrangement according to claim 1, wherein the at least one lighting unit elongates in a second length direction, L₂, parallel to the at least one first rotation axis, Aᵢ.
